(19) United States
(12) Patent Application Publication
(10) Pub. No.: US 2014/0071906 A1
(43) Pub. Date: Mar. 13, 2014

(54) APPARATUS AND METHOD FOR DISTRIBUTING TRAFFIC LOAD

(71) Applicant: FUJITSU LIMITED, Kawasaki-shi (JP)

(72) Inventor: Toshiyuki ICHINOE, Yokohama (JP)

(73) Assignee: FUJITSU LIMITED, Kawasaki-shi (JP)

(21) Appl. No.: 13/963,033

(22) Filed: Aug. 9, 2013

(30) Foreign Application Priority Data
Sep. 12, 2012 (JP) 2012-200709

(51) Int. Cl. H04W 72/04

(52) U.S. Cl. CPC H04W 72/04
USPC 370/329

(57) ABSTRACT

An apparatus stores association information that associates a plurality of identifiers identifiable by a load distribution device, with a plurality of communication lines. The load distribution device transfers user data for a mobile station device through one of the plurality of communication lines. The apparatus selects a first communication line via which the user data of the mobile station device is to be transferred, from among the plurality of communication lines, at the time of start of communication with the mobile station device. The apparatus identifies a first identifier that is associated with the first communication line in the association information, adds the first identifier to the user data, and outputs the user data to the load distribution device.

### CROSS-REFERENCE TO RELATED APPLICATION

This application is based upon and claims the benefit of priority from the prior Japanese Patent Application No. 2012-200709, filed on Sep. 12, 2012, the entire contents of which are incorporated herein by reference.

### FIELD

The embodiments discussed herein are related to apparatus and method for distributing traffic load.

### BACKGROUND

A base station apparatus that transfers user data of a mobile station device is coupled to a gateway device through an Internet Protocol (IP) communication path.

As a related technology, a method in a mobile telecommunications network including at least one access point and at least one gateway device is known. The method includes determining a security setting desired for a dedicated bearer signal by a network component and communicating the determined setting to a node desired for establishing communication. The method further includes configuring or selecting, by the access point, a secure protocol as desired between the access point and the gateway devices. The above determination is performed based on one or several of the network deployments being used and/or network operator policies.

As another related technology, a base station apparatus is known that includes a table generating unit that stories, in a forwarding table, a combination of: identifying information that specifies the communication pipe via which to transmit the data of another base station apparatus, which is set within a first logic communication path, and identifying information specifying the communication pipe via which to transmit the data of the other base station apparatus, which is set within a second logic communication path. The base station apparatus forwards the data of the another base station apparatus in the received pieces of data, on the basis of the communication pipe identifying information set in the received pieces of data and the forwarding table.

Japanese National Publication of International Patent Application No. 2011-504665 and Japanese Laid-open Patent Publication No. 2009-111641 contain information further to the related art technology discussed above.

### SUMMARY

According to an aspect of the invention, an apparatus stores association information that associates a plurality of identifiers identifiable by a load distribution device, with a plurality of communication lines. The load distribution device transfers user data for a mobile station device through one of the plurality of communication lines. The apparatus selects a first communication line via which the user data of the mobile station device is to be transferred, from among the plurality of communication lines, at the time of start of communication with the mobile station device. The apparatus identifies a first identifier that is associated with the first communication line in the association information, adds the first identifier to the user data, and outputs the user data to the load distribution device.

Various aspects of the invention will be realized and attained by means of the elements and combinations particularly pointed out in the claims.

It is to be understood that both the foregoing general description and the following detailed description serve as examples only and are merely explanatory, but are not intended to be restrictive of the aspects of the invention claimed.

### BRIEF DESCRIPTION OF DRAWINGS

FIG. 1 is a diagram illustrating a general arrangement example of a communication system, for use in accordance with aspects of the present invention;

FIG. 2 is a diagram illustrating an example of a hardware configuration of a base station apparatus, for use in accordance with aspects of the present invention;

FIG. 3 is a diagram illustrating an example of a hardware configuration of a mobility management entity/serving gateway (MME/SGW) device, for use in accordance with aspects of the present invention;

FIG. 4 is a diagram illustrating a first example of a function configuration of the base station apparatus, the MME/SGW device, a security architecture for Internet Protocol (IPSec) gateway device, and a router device, in accordance with aspects of the present invention;

FIG. 5 is a diagram illustrating an example of a transfer destination table, in accordance with aspects of the present invention;

FIG. 6 is a diagram illustrating an example of an address table, in accordance with aspects of the present invention;

FIG. 7 is a diagram illustrating an example of an operation in the base station apparatus, in accordance with aspects of the present invention;

FIG. 8 is a diagram illustrating an example of a line state table, in accordance with aspects of the present invention;

FIG. 9 is a diagram illustrating an example of a load state table, in accordance with aspects of the present invention;

FIG. 10 is a diagram illustrating an example of a determination operation of an access line, in accordance with aspects of the present invention;

FIG. 11 is a diagram illustrating a modification of the function configuration of the base station apparatus, the MME/SGW device, the IPSec gateway device, and the router device, in accordance with aspects of the present invention;

FIG. 12 is a diagram illustrating a second example of the function configuration of the base station apparatus, the MME/SGW device, the IPSec gateway device, and the router device, in accordance with aspects of the present invention;

FIG. 13 is a diagram illustrating an example of an address association table, in accordance with aspects of the present invention; and

FIG. 14 is a diagram illustrating an example of operations in the MME/SGW device, the IPSec gateway device, and the router device, in accordance with aspects of the present invention.

### DESCRIPTION OF EMBODIMENTS

Transfer rates of physical lines that constitute an IP communication path are defined, for example, at 10 Mbps, 100 Mbps, 1 Gbbs, and 10 Gbps, in accordance with a technical standard. By combining such a plurality of lines, an IP communication path having a desired transfer rate may be provided between the base station apparatus and the gateway device. When user traffic of the mobile station device is transferred through the IP communication path, a throughput may come close to the total transfer rate of the lines that constitute the IP communication path, by increasing the number of lines among which a transfer amount of the user traffic is distributable.

### 1. Hardware Configuration

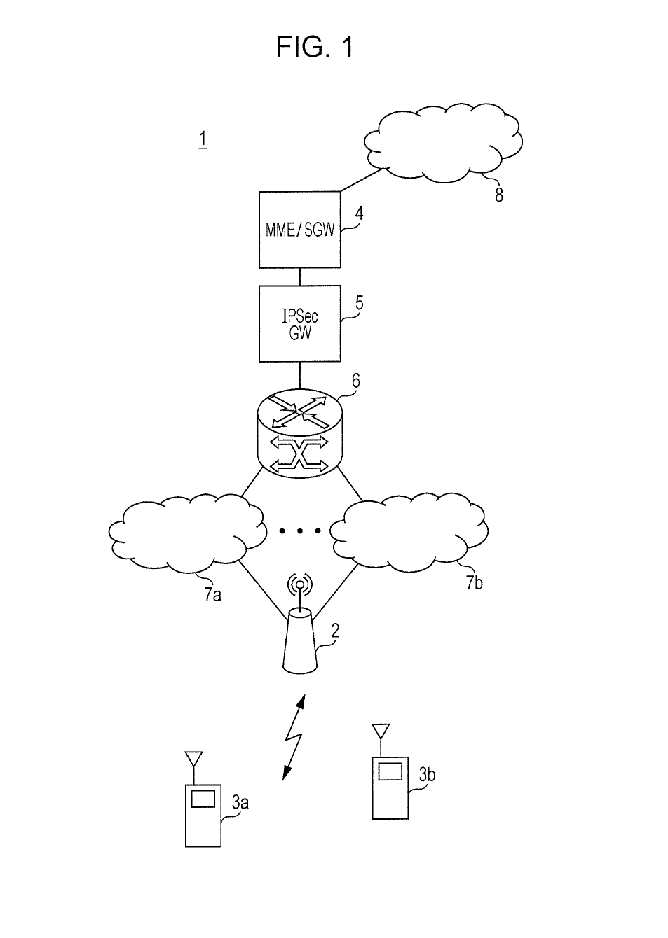

The embodiments discussed herein are described below with reference to the accompanying drawings. FIG. 1 is a diagram illustrating a general arrangement example of a communication system, usable in accordance with aspects of the present invention. In FIG. 1, the communication system 1 includes a base station apparatus 2, mobile station devices 3a and 3b, an MME/SGW device 4, an IPSec GW device 5, a router device 6, access lines 7a, 7b, . . . , and a host network 8. The communication system 1 is described below using Long Term Evolution (LTE), which has been reviewed in Third Generation Partnership Project (3GPP), as an example. The device and the method discussed herein may be applied to a mobile communication system having another scheme as long as the mobile communication system includes a communication apparatus that performs load distribution of a transfer amount of user data of the mobile station device, among a plurality of communication lines.

In the accompanying drawings and the following description, the base station apparatus, the mobile station device, the MME/SGW device, the IPSec GW device, and the router device may be interchangeably referred to as “base station”, “mobile station”, “MME/SGW”, “IPSec GW” and “router”, respectively. In addition, the mobile stations 3a and 3b, and the access lines 7a, 7b, . . . may be collectively referred to interchangeably as “mobile station 3” and “access line 7”, respectively.

The base station 2 relays communication between the mobile station 3 of a user who receives mobile communication service and a ground side wired communication network, in accordance with a certain wireless communication standard. The MME/SGW 4 transfers a user packet of the mobile station 3 between the host network 8 and the access line 7. In addition, the MME/SGW 4 executes mobility management, such as position registration of the mobile station 3, call processing at the time of incoming, and handover among radio base stations.

The IPSec GW 5 is provided for the MME/SGW 4 and executes encryption and decoding processing on the MME/SGW 4 side via IPSec communication of the user packet between the base station 2 and the MME/SGW 4. The base station 2 and the router 6 are coupled to each other through the plurality of the access lines 7a, 7b, . . . , which are IP communication paths, and load distribution of a transfer amount of the user packet between the base station 2 and the MME/SGW 4 is performed between the access lines 7a, 7b, . . . .

### <1.1. Hardware Configuration of the Base Station>

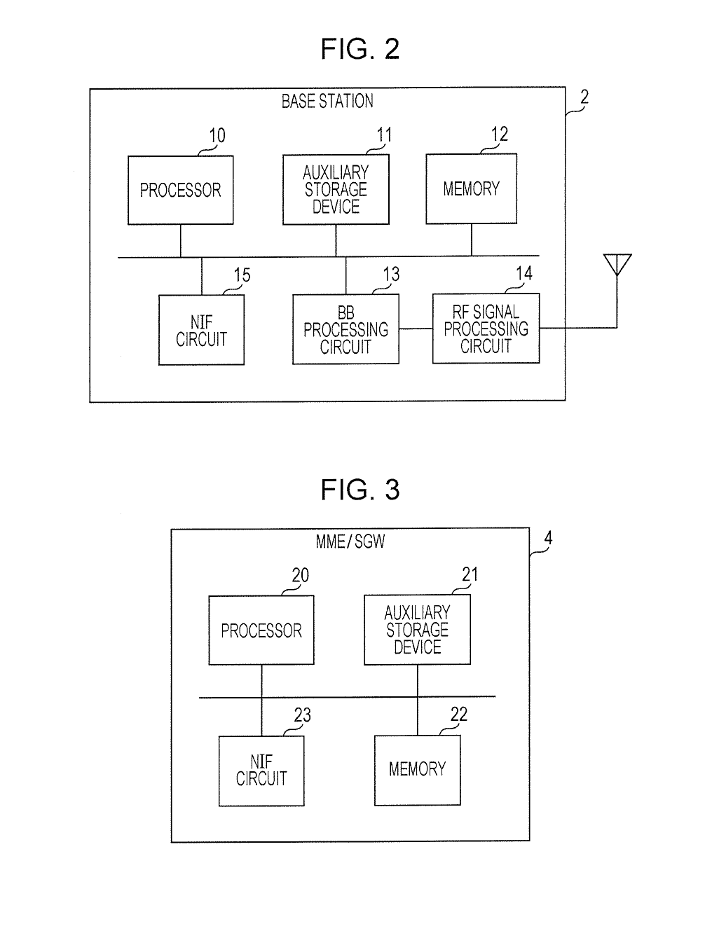

An example of a hardware configuration for the base station 2, for use in accordance with aspects of the present invention, is described below with reference to FIG. 2. The base station 2 includes a processor 10, an auxiliary storage device 11, a memory 12, a baseband processing circuit 13, a radio frequency signal processing circuit 14, and a network interface circuit 15. In the following description and the accompanying drawings, the baseband, the radio frequency, and the network interface are may be interchangeably referred to as “BB”, “RF”, and “NIF”, respectively.

The processor 10 executes operation control of the base station 2 and user management processing, other than the following processing, which is executed by the BB processing circuit 13. In the auxiliary storage device 11, a control program that is used for signal processing by the processor 10 and data that is used during execution of such a program are stored. The auxiliary storage device 11 may include a nonvolatile storage device, a read only memory (ROM), and/or a hard disk, or the like, which is used to store a computer program and data.

In the memory 12, a program that is currently being used by the processor 10 and data that is temporarily used by such a program are stored. The memory 12 may include a random access memory (RAM). The BB processing circuit 13 executes coding and modulation, demodulation and decoding of a signal, which is transmitted and received between the base station 2 and the mobile station 3, communication protocol processing, and processing of a BB signal that is related to scheduling. The BB processing circuit 13 may include a processor that is used for signal processing and a memory that is used to store a program and data that are used for an operation of the processor. In addition, the BB processing circuit 13 may include a logic circuit, such as a large scale integration (LSI), an application specific integrated circuit (ASIC), and a field-programming gate array (FPGA), which are used for the signal processing.

The RF signal processing circuit 14 executes digital/analogue conversion, analogue/digital conversion, frequency conversion, and signal amplification and filtering of a radio signal that is transmitted and received between the base station 2 and the mobile station 3. The NIF circuit 15 executes communication interface processing with the MME/SGW 4 and communication interface processing with another base station.

<1.2. Hardware Configuration of the MME/SGW, the IPSec GW, and the Router>

An example of a hardware configuration for the MME/SGW 4 is described below with reference to FIG. 3. The MME/SGW 4 includes a processor 20, an auxiliary storage device 21, a memory 22, and an NIF circuit 23. The processor 20 executes processing of mobility management, such as position registration of the mobile station 3, call processing at the time of incoming, and hand-over among radio base stations.

In the auxiliary storage device 21, a control program that is used for the above-described processing by the processor 20 and data that is used during execution of such a program are stored. The auxiliary storage device 21 may include a nonvolatile storage device, a ROM, a hard disk, or the like, which is used to store a computer program and data. In the memory 22, a program that is currently being executed by the processor 20, and data that is temporarily used by such a program are stored. The memory 22 may include a RAM. The NIF circuit 23 executes communication interface processing with the base station 2 and communication interface processing with the host network 8.

Hardware configurations of the IPSec GW 5 and the router 6 may be similar to the hardware configuration of the MME/SGW 4. The hardware configurations in FIGS. 2 and 3 are examples that are merely used to explain the example embodiments. The communication system discussed herein may employ any suitable hardware configuration as long as operations that are described below are executed in the hardware configuration.

### 2. First Embodiment

### 2.1. Function Configuration

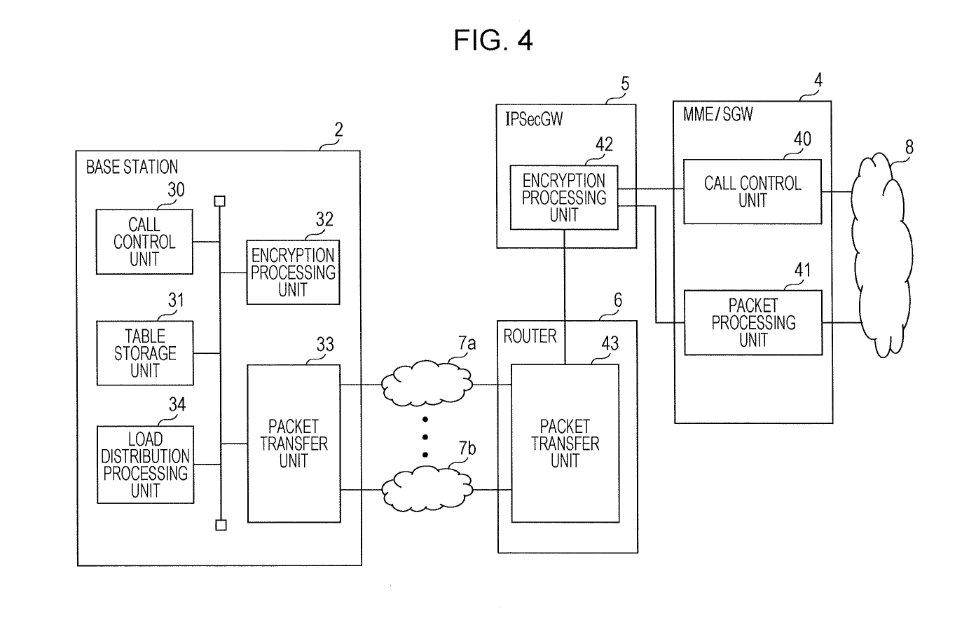

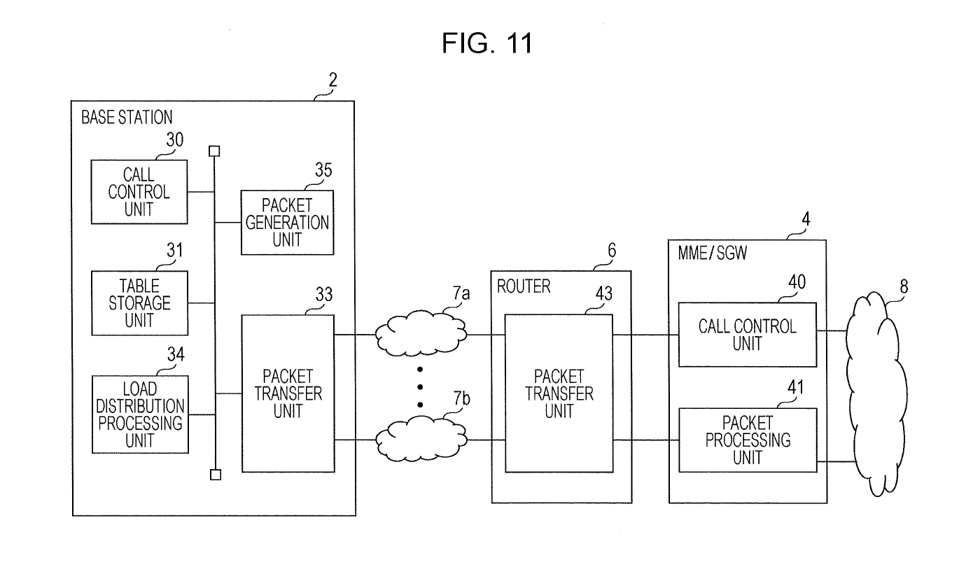

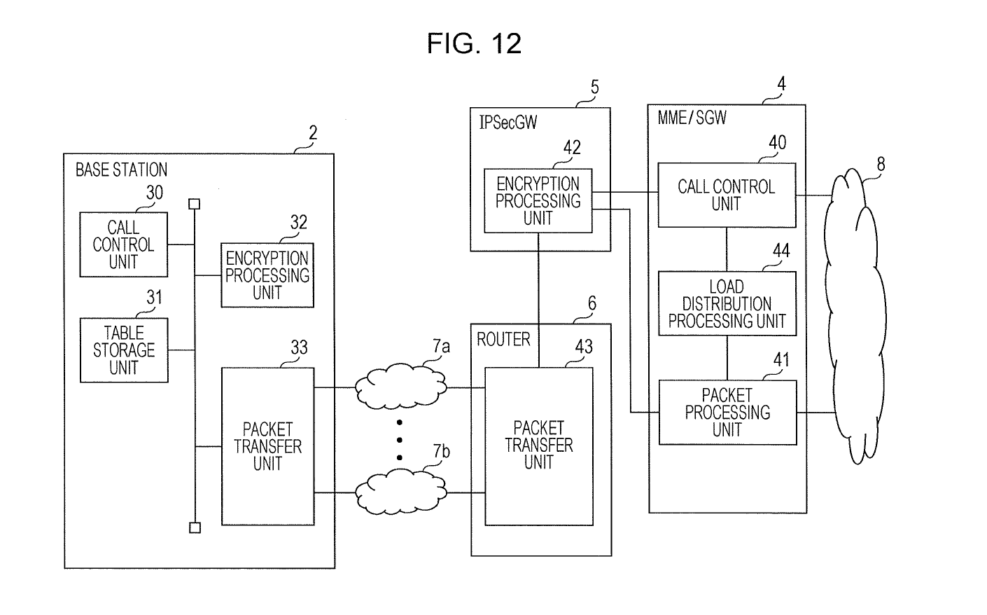

An example function that may be realized by the above-described hardware configuration is described below. FIG. 4 is a first example of a function configuration for the base station 2, the MME/SGW 4, the IPSec GW 5, and the router 6. In the function configuration of FIG. 4, a configuration of the base station 2, the MME/SGW 4, the IPSec GW 5, and the router 6 that are related to the functions described in the example embodiment illustrated below. The base station 2, the MME/SGW 4, the IPSec GW 5, and the router 6 may include configuration elements other than the illustrated configuration elements. Such a case may be applied to the function configuration in FIGS. 11 and 12, as well.

The base station 2 includes a call control unit 30, a table storage unit 31, an encryption processing unit 32, a packet transfer unit 33, and a load distribution processing unit 34. The MME/SGW 4 includes a call control unit 40 and a packet processing unit 41. The IPSec GW 5 includes an encryption processing unit 42. The router 6 includes a packet transfer unit 43.

The call control unit 30 of the base station 2 and the call control unit 40 of the MME/SGW 4 execute call control of traffic for the mobile station 3. When communication by the mobile station 3 is started, the call control units 30 and 40 start call connection in response to a call connection request by the mobile station 3, and establish a user plane (U-plane) bearer that is used to transfer user data for the mobile station 3.

When the U-plane bearer is established, the IP address of the base station 2 and the IP address of the MME/SGW 4 are exchanged between the call control units 30 and 40 as a transmission source address for a user packet of the mobile station 3, for each of the U-plane bearers. The packet transfer unit 33 of the base station 2 and the packet processing unit 41 of the MME/SGW 4 execute U-plane bearer communication via the access line 7 using such address setting information.

The packet transfer unit 33 of the base station 2, and the packet transfer unit 43 of the router 6, execute load distribution processing in distributing a transfer amount of the user data of the mobile station 3 among the plurality of the access lines 7a, 7b, . . . . The encryption processing unit 32 of the base station 2 and the encryption processing unit 42 of the IPSec GW 5 establish an IPSec session and perform transmission and reception of the user data for the mobile station 3 using IPSec encryption communication.

The load distribution processing unit 34 of the base station 2 determines the access line 7 that is used to transfer the user data for the mobile station 3, at the time of establishment of the U-plane bearer for the mobile station 3. In addition, the load distribution processing unit 34 identifies identifier information associated with the determined access line 7, from among plural pieces of identifier information that are respectively associated with the access lines 7 and are allowed to be used for the load distribution processing of the packet transfer unit 33. The load distribution processing unit 34 specifies the identified identifier information as identifier information that is used to select the access line 7, which in turn is used to transfer the user data of the mobile station 3, via load distribution processing.

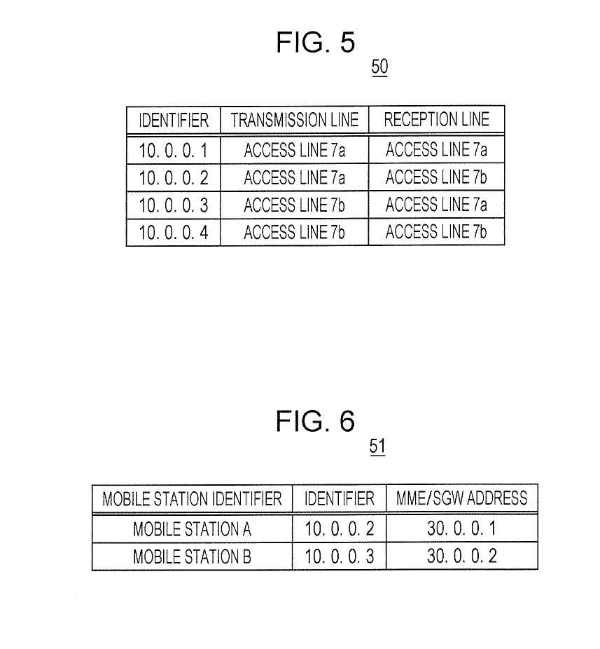

The table storage unit 31 may store, for example, a transfer destination table 50 illustrated in FIG. 5 as association information that associates each of the access lines 7 and identifier information. The load distribution processing unit 34 identifies identifier information that is associated with the access line 7 that is used to transfer the user data of the mobile station 3, by referring to the transfer destination table 50.

In the example of the transfer destination table 50 illustrated in FIG. 5, as the identifier information that is used for the load distribution processing, a plurality of IP addresses that are assigned to the base station 2 are used. The IP address of the base station 2 is set to an IP header for the user packet as a transmission source address, and is used to select each of the access lines 7 that serves as a transfer destination in the load distribution processing by the packet transfer unit 33.

The transfer destination table 50 includes information elements: “identifier”, “transmission line”, and “reception line”. The information element “identifier” identifies one of the plurality of IP addresses that are assigned to the base station 2. The information element “transmission line” specifies the access line 7 that is used to transfer a user packet that has an IP address identified by the corresponding “identifier” as a transmission source. The information element “reception line” indicates the access line 7 through which the packet transfer unit 43 of the router 6 transfers a user packet that has an IP address identified by the corresponding “identifier” as a transmission destination.

For example, the second row of the transfer destination table 50 indicates that a user packet having an IP address “10.0.0.2,” which is assigned to the base station 2 as a transmission source, is transferred to the access line 7a in the load distribution processing via the packet transfer unit 33. In addition, in load distribution processing by the packet transfer unit 43, the user packet having the IP address “10.0.0.2” as its transmission destination is transferred to the access line 7b. For example, the transfer destination table 50 is provided as set by a network designer. In the following description, an example is used in which an IP address is assigned to the base station 2 as identifier information, which in turn is used for load distribution processing.

At the time of call connection, the call control unit 30 notifies the call control unit 40 in the MME/SGW 4, of the IP address of the base station 2, to which the U-plane bearer of the mobile station 3 is set, by referring to the load distribution processing unit 34 for the IP address of the base station 2, which is used for the U-plane bearer of the mobile station 3.

The load distribution processing unit 34, to which the IP address of the base station 2 is referred, determines the access line 7 that is used for data transfer in the U-plane bearer of the mobile station 3. The load distribution processing unit 34 searches the transfer destination table 50 for an IP address that corresponds to the access line 7, and outputs the IP address to the call control unit 30.

The call control unit 30 notifies the call control unit 40 of the IP address that is obtained from the load distribution processing unit 34. The call control unit 30 receives the IP address of the MME/SGW 4 from the call control unit 40 of the MME/SGW 4 to which the U-plane bearer of the mobile station 3 is set. The call control unit 30 stores the IP address that is obtained from the load distribution processing unit 34, an identifier of the mobile station 3, and an IP address for the MME/SGW 4 in the table storage unit 31.

The table storage unit 31 may store, for example, an address table 51 that associates an IP address of the base station 2, as specified by the load distribution processing unit 34 for the mobile station 3, and the mobile station 3, with an IP address of the MME/SGW 4. FIG. 6 is a diagram illustrating an example of the address table 51. The address table 51 includes information elements such as “mobile station identifier”, “identifier”, and “MME/SGW address”.

The information element “mobile station identifier” indicates an identifier that is assigned to the mobile station 3. The information element “identifier” indicates an IP address of the base station 2, which the load distribution processing unit 34 specifies for the mobile station 3. The information element “MME/SGW address” is an IP address of the MME/SGW 4, to which the U-plane bearer of the mobile station 3 is set.

For example, the first row of the address table 51 indicates that the load distribution processing unit 34 specifies the IP address “10.0.0.2” of the base station 2 for the mobile station 3 to which an identifier “mobile station A” is assigned. In addition, the IP address of the MME/SGW 4, to which the U-plane bearer of the mobile station 3 is set, is “30.0.0.1”.

The encryption processing unit 32 encrypts the user data that is received from the mobile station 3, and stores the encrypted user data in a packet. The encryption processing unit 32 searches the address table 51 for an IP address of the base station 2, which is specified for the mobile station 3, and sets the IP address to an IP header of the packet as a transmission source address.

The encryption processing unit 32 searches the address table 51 for the IP address of the MME/SGW 4, to which the U-plane bearer of the mobile station 3 is set. The encryption processing unit 32 sets an IP address for the IPSec GW 5, which executes IPSec processing for IPSec communication of the MME/SGW 4 for the searched IP address, to the IP header of the packet as the transmission destination address. The encryption processing unit 32 transmits the packet in which the encrypted user data is stored to the packet transfer unit 33.

The packet transfer unit 33 executes load distribution processing to distribute a transfer amount of the packet among the access lines 7a, 7b, . . . on the basis of the information that is stored in the IP header in unencrypted form in the packet that is received from the encryption processing unit 32.

### 2.2. Description of an Operation

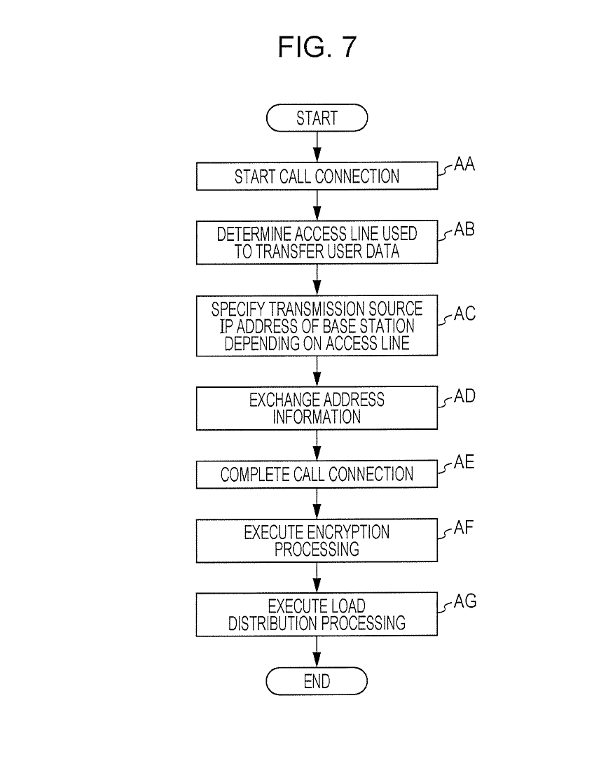

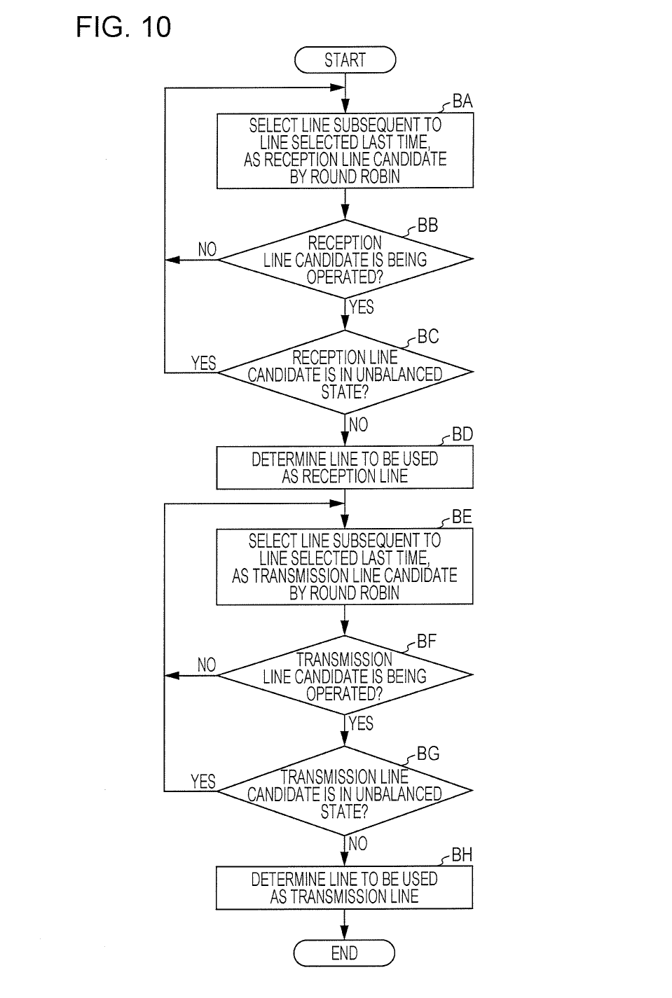

Example operation of the base station 2 is described below. FIG. 7 is a diagram illustrating an example of operation in the base station 2. The series of operations that are described below with reference to FIG. 7 may be viewed as a method that includes a plurality of procedures. This view is applied to the Operations illustrated in FIGS. 10 and 14.

As shown in FIG. 7, when a call connection request is issued by the mobile station 3, in Operation AA, the call control unit 30 starts call connection with the call control unit 40 of the MME/SGW 4. The call control unit 30 refers to the load distribution processing unit 34 for the IP address of the base station 2, which is used as a transmission source address when the user data of the mobile station 3 is transmitted from the base station 2.

In Operation AB, the load distribution processing unit 34 determines the access line 7 that is used to transfer the user data of the mobile station 3. In Operation AC, the load distribution processing unit 34 searches the transfer destination table 50 for an IP address that corresponds to the access line 7, and specifies the IP address as the IP address of the base station 2. In Operation AD, the IP address of the base station 2 and the IP address of the MME/SGW 4 are exchanged between the call control units 30 and 40. In Operation AE, the call control unit 30 executes the remaining processing of the call connection and completes the call connection.

When the user data arrives from the mobile station 3, in Operation AF, the encryption processing unit 32 encrypts the user data and stores the encrypted user data in a packet. The encryption processing unit 32 sets the IP addresses of the base station 2 to an IP header of the packet as the transmission source address. The encryption processing unit 32 sets the IP address of the IPSec GW 5 for the MME/SGW 4 in the IP header of the packet as a transmission destination address. In Operation AG, the packet transfer unit 33 executes the distribution processing of the transfer mount of the packet, on the basis of the IP header information of the packet in which the encrypted user data is stored.

A determination operation for the access line 7 as performed by the load distribution processing unit 34 in Operation AB is described below. The load distribution processing unit 34 may determine whether the access line 7 may be used to transfer the user data of the mobile station 3, depending on the state of the access line 7.

For example, the load distribution processing unit 34 may determine whether the access line 7 is to be used to transfer the user data of the mobile station 3 depending on whether the access line 7 is operated or stopped. Therefore, the table storage unit 31 may store a line state table 52 that is used to record the state of the access line 7.

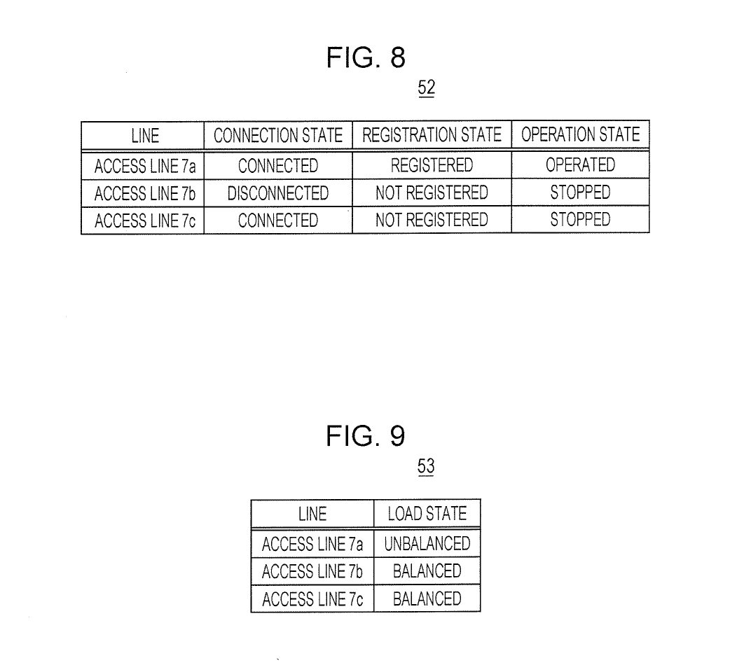

FIG. 8 is a diagram illustrating an example of the line state table 52. The line state table 52 includes information elements “line”, “connection state”, “registration state”, and “operation state”. The information element “line” indicates an identifier for each of the access lines 7. The information element “connection state” indicates a connection state of a physical link of each of the access lines 7. A value of the information element “connection state” when the physical link is established is “connected”, and a value of the information element “connection state” when the physical link is not established is “disconnected”.

The information element “registration state” indicates whether or not each of the access lines 7 is registered, in the transfer destination table 50, in association with the information element “transmission line” and “reception line”. The information element “operation state” indicates whether or not the access line 7 is operated. The information element “operation state” stores the value “operated” when the value of the information element “connection state” is “connected,” and the value of the information element “registration state” is “registered”; and the information element “operation state” stores the value “stopped” in cases otherwise.

For example, the first row of the line state table 52 indicates that the access line 7a is operated because the physical link of the access line 7a is established and the registration to the transfer destination table 50 is performed. The second row of the line state table 52 indicates that the access line 7b is stopped because the physical link of the access line 7b is not established. The third row of the line state table 52 indicates that the access line 7c is stopped because the access line 7c is not registered to the transfer destination table 50.

By referring to the line state table 52, the load distribution processing unit 34 determines whether the target access line 7 is operated or stopped when the value of the information element “operation state” to which the target access line 7 is recorded is “operated” or “stopped”, respectively. In the line state table 52, in another embodiment, the information elements “registration state” and “operation state” may be held independently, for each of a transmission line and a reception line. The load distribution processing unit 34 may independently determine the operation state of the access line 7, depending on whether the access line 7 is used as the transmission line or the reception line.

In addition, for example, the load distribution processing unit 34 may determine the access line 7 that is used to transfer the user data of the mobile station 3, depending on whether or not the load of the target access line 7 has a more unbalanced load than that of another line. The table storage unit 31 may thereby store a load state table 53 that is used to record the load state of the access line 7.

FIG. 9 is a diagram illustrating an example of the load state table 53. The load state table 53 includes information elements “line” and “load state”. The information element “line” indicates an identifier for each of the access lines 7. The information element “load state” indicates a load state for each of the access lines 7. When the load of the target access line 7 is higher and more unbalanced than the load of another line, the information element “load state” stores a value “unbalanced”. Otherwise, the information element “load state” stores a value “balanced”.

The load distribution processing unit 34 measures the load state of each of the access lines 7 and updates the load state table 53. An example of update processing of the load state table 53 by the load distribution processing unit 34 is described below.

The load distribution processing unit 34 measures a bandwidth Ue being used in the access line 7 that are to be updated, and the distribution processing unit 34 also measures a total Ua of bandwidths being used in all of the operated access lines 7. The full bandwidth of the access lines 7 that are to be updated may be represented as “Be”, and the full bandwidth of all of the access lines 7 that are currently in operation may be represented as “Ba”. The load distribution processing unit 34 changes the indicated load state of the access line 7 that is to be updated, from the balanced state to the unbalanced state, when the following formula (1) is satisfied (“Th1” represents a certain threshold value):

Ue/Ua>Be/Ba×(1+Th1) (1)

Alternatively, the load distribution processing unit 34 may change the load state of the access line 7 that is the update target, from the unbalanced state to the balanced state when the following formula (2) is satisfied. “Th2” represents a certain threshold value that is less than or equal to “Th1”.

Ue/Ua≦Be/Ba×(1+Th2) (2)

The determination operation of the access line by the load distribution processing unit 34 is described with reference to FIG. 10. In Operation BA, the load distribution processing unit 34 selects a reception line candidate using a “Round Robin” type scheme. The load distribution processing unit 34 selects the access line 7 subsequent to the access line 7 that has been selected in Operation BA the previous time, as a reception line candidate, from the access lines 7 that has been ordered.

In Operation BB, the load distribution processing unit 34 determines whether or not the reception line candidate is being operated. When the reception line candidate is being operated (Yes in Operation BB), the flow proceeds to Operation BC. When the reception line candidate is not being operated (No in Operation BB), the flow proceeds to Operation BA.

In Operation BC, the load distribution processing unit 34 determines whether or not the reception line candidate is in an unbalanced state. When the reception line candidate is not in an unbalanced state (No in Operation BC), the flow proceeds to Operation BD. When the reception line candidate is in an unbalanced state (Yes in Operation BC), the flow returns to Operation BA. In Operation BD, the load distribution processing unit 34 determines that the reception line candidate that is currently selected is to be a reception line of the user data of the mobile station 3. After that, the flow proceeds to Operation BE.

In Operation BE, the load distribution processing unit 34 selects a transmission line candidate using the Round Robin scheme. The load distribution processing unit 34 selects the access line 7 subsequent to the access line 7 that was selected in Operation BE previously as the transmission line candidate.

In Operation BF, the load distribution processing unit 34 determines whether or not the transmission line candidate is being operated. When the transmission line candidate is being operated (Yes in Operation BF), the flow proceeds to Operation BG. When the transmission line candidate is not being operated (No in Operation BF), the flow returns to Operation BE.

In Operation BG, the load distribution processing unit 34 determines whether or not the transmission line candidate is in an unbalanced state. When the transmission line candidate is not in an unbalanced state (No in Operation BG), the flow proceeds to Operation BH. When the transmission line candidate is in an unbalanced state (Yes in Operation BG), the flow returns to Operation BE. In Operation BH, the load distribution processing unit 34 determines that the transmission line candidate that is currently selected is to be a transmission line for the user data of the mobile station 3.

The above-described operations of the call control unit 30 and the load distribution processing unit 34 are executed by the processor 10 illustrated in FIG. 2. The above-described operations of the encryption processing unit 32 and the packet transfer unit 33 are executed by the NIF circuit 15 illustrated in FIG. 2. In addition, the above-described operation of the call control unit 40 is executed by the processor 20 illustrated in FIG. 3. The above-described operation of the packet processing unit 41 is executed by the NIF circuit 23 illustrated in FIG. 3. The above-described operation of the encryption processing unit 42 is executed by a processor that is included in the IPSec GW 5. The above-described operation of the packet transfer unit 43 is executed with the cooperation of a processor and a NIF circuit that are included in the router 6. Storage areas of the transfer destination table 50, the address table 51, the line state table 52, and the load state table 53 are provided in the auxiliary storage device 11 or the memory 12.

### 2.3. Effects of the Embodiments

In some embodiments, load distribution processing for distributing a transfer amount of the user data of the mobile station 3 to a plurality of access lines may be executed on the basis of certain identifier information that is specified for each of the U-plane bearers of the mobile station 3, selected from a plurality of pieces of identifier information. As a result, the number of lines that are determined for use for distribution increases as the number of pieces of identifier information increases, and the efficiency of the load distribution of the transfer amount of the user data of the mobile station 3 is thereby improved.

By assigning a plurality of IP addresses to the base station 2 and by utilizing the IP addresses of the base station 2 as identifier information for load distribution processing, the identifier information may be stored in an IP header that is not encrypted in the IPSec communication between the base station 2 and the MME/SGW 4. As a result, even when the IPSec communication is executed between the base station 2 and the MME/SGW 4, the load distribution processing is executed on the basis of the identifier information that is specified for each of the U-plane bearers, and efficiency of load distribution of the user data of the mobile station 3 may thereby be improved.

In addition, the MME/SGW 4 is notified of the IP address of the base station 2, and the IP address is used as a transmission destination address of the user packet that is transmitted from the MME/SGW 4. As a result, the IP address of the base station 2 may also be used for load distribution processing when the router 6, which is a counterpart device to the base station 2, transfers user data for the mobile station 3 to the base station 2. Thus, the efficiency of load distribution of a transfer amount of the user data of the mobile station 3 by the counterpart device of the base station 2 is also improved.

In addition, communication failures are avoided by determining the operation state of the access line 7 and determining the access line 7 that is used to transfer the user data of the mobile station 3 based on the operation state, such that occurrence of reduction in throughput of transfer of the user data of the mobile station 3 is decreased. In addition, overflow due to concentration of traffic on the some access lines 7 is avoided by determining the access line 7 depending on the load state of the access line.

In addition, as described with reference to FIG. 10, the load distribution processing unit 34 selects a line that is used as the reception line, depending on the operation state and the load state of the access line 7, and specifies identifier information that is used for the load distribution processing, depending on the selected reception line. As a result, when the identifier information is used for load distribution processing in the router 6, operating as the counterpart device, communication failures or the reception line and overflow are avoided.

### 2.4. Modifications

In the above-described embodiment, the IPSec communication is executed between the base station 2 and the MME/SGW 4, and alternatively, the IPSec communication may not need to be executed in other embodiments. In such cases, as illustrated in FIG. 11, the IPSec GW 5 is omitted. In addition, a packet generation unit 35 is provided in the base station 2, instead of the encryption processing unit 32 or in addition to the encryption processing unit 32. The packet generation unit 35 generates a packet in which the user data received from the mobile station 3 is stored, and sets the IP addresses of the base station 2 and the MME/SGW 4 to an IP header of the packet, as a transmission source address and a transmission destination address. The above-described operation of the packet generation unit 35 is executed by the NIF circuit 15 illustrated in FIG. 2.

In addition, in the above-described embodiment, the IP address of the base station 2 is used as the identifier information that is used for load distribution processing. Alternatively, identifier information other than the IP address of the base station 2 may be utilized in other embodiments. For example, the identifier information that is used for load distribution processing may be information that is set to the IP header of the packet as extended information.

### 3. Second Embodiment

An example of the communication system 1 according to a second embodiment is described below. In the second embodiment, a plurality of addresses are assigned to the IPSec GW 5 and used as identifier information that in turn is used for the load distribution processing. FIG. 12 is a diagram illustrating a second example of the function configuration of the base station 2, the MME/SGW 4, the IPSec GW 5, and the router 6. For various features of this configuration example that are similar to those in the configuration example illustrated in FIG. 4, the same reference symbols are used, and repetition of corresponding description is omitted.

The MME/SGW 4 includes a load distribution processing unit 44. The load distribution processing unit 44 determines the access line 7 that is used to transfer the user data of the mobile station 3 at the time of establishment of the U-plane bearer of the mobile station 3. In addition, the load distribution processing unit 44 identifies identifier information that is associated with the determined access line 7, from the plurality of IP addresses assigned to the MME/SGW 4. The MME/SGW 4 may store a table that is similar to the transfer destination table 50 illustrated in FIG. 5, as association information that associates each of the access lines 7 and the IP address of the MME/SGW 4.

At the time of call connection, the call control unit 40 notifies the call control unit 30 of the base station 2, of the IP address of the MME/SGW 4 to which the U-plane bearer of the mobile station 3 is set. As a result, the call control unit 40 refers to the load distribution processing unit 44 for an IP address of the MME/SGW 4, which is used for the U-plane bearer of the mobile station 3.

The load distribution processing unit 44, to which the IP address of the MME/SGW 4 is referred, determines the access line 7 that is used for data transfer in the U-plane bearer of the mobile station 3. The method of determining the access line 7 may be similar to the method that is described with reference to FIG. 10, for example. The load distribution processing unit 44 may execute test communication through each of the access lines 7 and detect a connection state of the physical link of each of the access lines 7. The test communication may be, for example, a ping, or the like. The load distribution processing unit 34 selects an IP address that corresponds to the access line 7 from the plurality of IP addresses of the MME/SGW 4 and outputs the selected IP address to the call control unit 40.

The call control unit 40 notifies the call control unit 30 of the IP address that is obtained from the load distribution processing unit 44. The call control unit 40 receives the IP address of the base station 2 from the call control unit 30 of the base station 2, to which the U-plane bearer of the mobile station 3 is set.

When the packet processing unit 41 receives the user data to be transmitted to the mobile station 3, the packet processing unit 41 sets the IP address of the MME/SGW 4, which is obtained from the load distribution processing unit 44, to an IP header of a packet, in which the user data is stored as a transmission source address. In addition, the packet processing unit 41 sets the IP addresses of the base station 2 to the IP header as a transmission destination address. The packet processing unit 41 transmits the packet to the encryption processing unit 42 of the IPSec GW 5.

The encryption processing unit 42 assigns an IP header to encapsulate the received packet after encrypting the packet. To the IPSec GW 5, a plurality of IP addresses are assigned, and the IP addresses of the MME/SGW 4 respectively correspond to the plurality of IP addresses of the IPSec GW 5. For example, the IP address of the MME/SGW 4 may be associated with the IP address of the IPSec GW 5 one-to-one.

The encryption processing unit 42 sets the IP address of the IPSec GW 5, which is associated with the IP address of the MME/SGW 4 in turn, set to header information of the received packet, to an IP header that is assigned to the encapsulated packet as a transmission source address. The encryption processing unit 42 may store an address association table that associates the IP address of the MME/SGW 4 with the address of the IPSec GW 5.

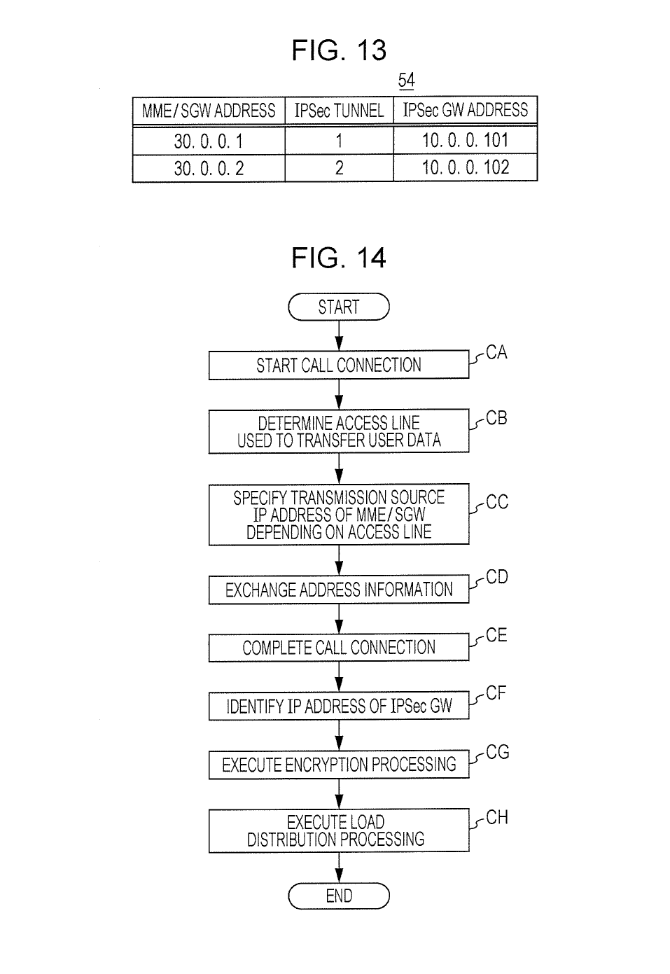

FIG. 13 is a diagram illustrating an example of an address association table 54. The address association table 54 includes information elements “MME/SGW address”, “IPSec tunnel”, and “IPSec GW address”. The information element “MME/SGW address” indicates an IP address of the MME/SGW 4. The information element “IPSec GW address” indicates an IP address of the IPSec GW 5 that is associated with each of the IP addresses of the MME/SGW 4. The information element “IPSec tunnel” indicates an identifier of an IPSec tunnel through which a packet in which each of the IP addresses of the MME/SGW 4 is set as a transmission source address is transferred.

For example, the first row of the address association table 54 indicates that a packet in which the IP address “30.0.0.1” of the MME/SGW 4 is set as a transmission source address is transferred through an IP tunnel having an identifier “1”. In addition, the IP address “30.0.0.1” of the MME/SGW 4 is associated with an IP address “10.0.0.101” of the IPSec GW 5.

The packet transfer unit 43 of the router 6 executes load distribution processing for distributing a transfer amount of the encapsulated packet among the access lines 7a, 7b, . . . , on the basis of information that is stored in the IP header in an unencrypted form of the packet that is tunneled by the encryption processing unit 42.

In addition, when the user data of the mobile station 3 is transferred from the base station 2 to the MME/SGW 4, the encryption processing unit 32 identifies an IP address of the IPSec GW 5, which corresponds to the IP address of the MME/SGW 4, for which notification is received from the call control unit 40. As a result, the encryption processing unit 32 may store a table that is similar to the address association table 54 illustrated in FIG. 13. The encryption processing unit 32 sets the identified IP address of the IPSec GW 5 to an IP header of a packet as the transmission destination address. The packet transfer unit 33 executes the load distribution processing of the transfer amount of the packet, on the basis of the information that is stored in the IP header (in unencrypted form) of the packet that is received from the encryption processing unit 32.

FIG. 14 is a diagram illustrating an example of operation in the MME/SGW 4, the IPSec GW 5, and the router 6. In Operation CA, the call control unit 40 starts the call connection, together with the call control unit 30 of the base station 2. The call control unit 40 refers to the load distribution processing unit 44 for an IP address of the MME/SGW 4, which is used as a transmission source address when the user data of the mobile station 3 is transmitted from the MME/SGW 4.

In Operation CB, the load distribution processing unit 44 determines the access line 7 that is used to transfer the user data of the mobile station 3. In Operation CC, the load distribution processing unit 44 determines an IP address that corresponds to the access line 7 and specifies the determined IP address as the IP address of the MME/SGW 4. In Operation CD, the IP address of the MME/SGW 4 and the IP address of the base station 2 are exchanged between the call control units 30 and 40. In Operation CE, the call control unit 40 completes the call connection after executing the remaining processing of the call connection.

When the user data to be transmitted to the mobile station 3 arrives, in Operation CF, the packet processing unit 41 sets the IP address of the MME/SGW 4 to an IP header of packet in which the user data is stored, as a transmission source address. The encryption processing unit 42 identifies an address of the IPSec GW 5 that is associated with the IP address of the MME/SGW 4.

In Operation CG, the encryption processing unit 42 assigns the IP header in which the address of the IPSec GW 5 is set as a transmission source address to encapsulate the packet after encrypting the packet. In Operation CH, the packet transfer unit 43 executes distribution processing of the transfer amount of the packet, on the basis of the IP header information of the encapsulated packet.

In this embodiment, in the transfer of the user data of the mobile station 3, a plurality of IP addresses that are assigned to the single IPSec GW 5 may be set to an IP header as a transmission source address and a transmission destination address. As a result, in the load distribution processing for distributing a transfer mount of the user data of the mobile station 3 to a plurality of access lines, when the address of the IPSec GW 5, which is specified as the transmission source address or the transmission destination address, is used, the efficiency of the load distribution of the transfer amount of the user data is improved.

The above-described operation of the load distribution processing unit 44 is executed by the processor 20 illustrated in FIG. 3. In addition, a storage area of the address association table 54 is provided in the auxiliary storage device 21 or the memory 22.

All examples and conditional language recited herein are intended for pedagogical purposes to aid the reader in understanding as parts of the embodiment and the concepts contributed by the inventor(s) to furthering the art, and are to be construed as being without limitation to such specifically recited examples and conditions, nor does the organization of such examples in the specification relate to a showing of the superiority and/or inferiority of various aspects of the embodiments as described. Although example embodiments have been described in detail, it should be understood that the various changes, substitutions, and alterations could be made hereto without departing from the spirit and scope hereof.

What is claimed is:

1. A communication apparatus, comprising:
a data transfer unit configured to transfer user data for a mobile station device through one of a plurality of communication lines;
a storage unit configured to store association information that associates a plurality of identifiers identifiable by the data transfer unit, with the plurality of communication lines;
a line selection unit configured to select a first communication line via which the user data of the mobile station device is to be transferred, from among the plurality of communication lines available for selection, at the time of start of communication with the mobile station device;
an identifier identification unit configured to identify a first identifier that is associated with the first communication line selected by the line selection unit in the association information; and
an identifier addition unit configured to add the first identifier identified by the identifier identification unit to the user data, and to output the user data to the data transfer unit.

2. The communication apparatus of claim 1, wherein
the line selection unit selects the first communication line from among the plurality of communication lines, depending on a state of each of the plurality of communication lines.

3. The communication apparatus of claim 2, wherein
the line selection unit selects the first communication line from among the plurality of communication lines, depending on whether or not data transfer via each of the plurality of communication lines is available.

4. The communication apparatus of claim 2, wherein
the line selection unit selects the first communication line from among the plurality of communication lines, depending on a load state of each of the plurality of the communication lines.

5. The communication apparatus of claim 1, wherein
the plurality of identifiers are selected from a plurality of addresses that are assigned to the communication apparatus.

6. The communication apparatus of claim 5, further comprising:
an address notification unit that notifies another communication apparatus that transfers the user data of the mobile station device to the communication apparatus, of the address of the communication apparatus, which is identified by the identifier identification unit, as a destination address that is used to transfer the user data of the mobile station device from the another communication apparatus.

7. A communication system including a plurality of computers coupled to each other through a network, the communication system comprising:
a data transfer unit configured to transfer user data for a mobile station device through one of a plurality of communication lines;
a storage unit configured to store association information that associates a plurality of identifiers identifiable by the data transfer unit, with the plurality of communication lines;
a line selection unit configured to select a first communication line via which the user data of the mobile station device is to be transferred, from among the plurality of communication lines available for selection, at the time of start of communication with the mobile station device;
an identifier identification unit configured to identify a first identifier that is associated with the first communication line selected by the line selection unit in the association information; and
an identifier addition unit configured to add the first identifier identified by the identifier identification unit to the user data, and to output the user data to the data transfer unit.

8. A communication method, comprising:
storing association information that associates a plurality of identifiers that are identifiable by a load distribution device, with a plurality of communication lines, the load distribution device transferring user data for a mobile station device through one of the plurality of communication lines;
selecting a first communication line via which the user data of the mobile station device is to be transferred, from among the plurality of communication lines, at the time of start of communication with the mobile station device;
identifying a first identifier that is associated with the first communication line in the association information; and
adding the first identifier to the user data, and outputting the user data to the load distribution device.
